(19) United States
(12) Patent Application Publication
(10) Pub. No.: US 2025/0373436 A1
(43) Pub. Date: Dec. 4, 2025

(54) INFORMATION PROCESSING SYSTEM, NON-TRANSITORY COMPUTER READABLE MEDIUM, AND METHOD

(71) Applicant: FUJIFILM Business Innovation Corp., Tokyo (JP)

(72) Inventor: Yoshikazu UGAI, Kanagawa (JP)

(73) Assignee: FUJIFILM Business Innovation Corp., Tokyo (JP)

(21) Appl. No.: 19/305,402

(22) Filed: Aug. 20, 2025

(30) Foreign Application Priority Data
Jan. 24, 2024 (JP) 2025-010346

(51) Int. Cl. H04L 9/32

(52) U.S. Cl. CPC H04L 9/3226; H04L 9/3213

(57) ABSTRACT

An information processing system includes: multiple information processing apparatuses; and a management server that manages the multiple information processing apparatuses, in which each of the information processing apparatuses includes a first processor, in which the first processor is configured to: perform an authentication process for a user by using first identification information and first password information that are inputted by the user and permit the user who succeeds the authentication process to use a corresponding one of the information processing apparatuses in a case where a result of the authentication process is successful; transmit second identification information and second password information to an external server that manages an additional service and request the external server to perform the authentication process in a case where the second identification information and the second password information are inputted by the user to use the service that is usable in the corresponding one of the information processing apparatuses; and permit the user to use the service and transmit authentication token information that is transmitted when the external server sends back a message that represents success of authentication and user information that enables the user to be identified to the management server in a case where the external server sends back the message that represents the success of authentication, in which the management server includes a second processor and a storage unit, in which the second processor is configured to: acquire data relevant to a state of the multiple information processing apparatuses by synchronously communicating with the multiple information processing apparatuses to be managed and store the data as synchronous data in the storage unit; and associate the authentication token information that is transmitted from the first processor with the user information and store the authentication token information in the synchronous data of the corresponding one of the information processing apparatuses that transmits the authentication token information and in the synchronous data of another information processing apparatus that implements authentication management in common with the corresponding one of the information processing apparatuses, in which the first processor is configured to transmit the user information about the user who logs in to the management server in a case where the user performs the authentication process by using the first identification information and the first password information, in which the second processor is configured to transmit the authentication token information to the corresponding one of the information processing apparatuses that transmits the user information in a case where the authentication token information that is associated with the user information that is transmitted from the first processor is stored in the synchronous data of any one of the information processing apparatuses that implements the authentication management in common, and in which the first processor is configured to request the external server to perform the authentication process by using the authentication token information that is transmitted from the second processor and permit the user to use the service in a case where the external server sends back the message that represents the success of authentication.

### CROSS-REFERENCE TO RELATED APPLICATIONS

This application is based on and claims priority under 35 USC 119 from Japanese Patent Application No. 2025-010346 filed Jan. 24, 2025.

### BACKGROUND

### (i) Technical Field

The present disclosure relates to an information processing system, a non-transitory computer readable medium, and a method.

### (ii) Related Art

A collaborative authorization system disclosed in Japanese Unexamined Patent Application Publication No. 2020-003877 includes an authorization unit that authorizes a user, based on inside user information that is inputted through a login operation into an information processing apparatus, a collaborative authorization information retaining unit that stores collaborative authorization information that contains the inside user information in the case where the inside user information matches outside user information that is inputted to use a service that is provided via a network, and a collaborative authorization controller that controls permission to use the service to the user who logs in the information processing apparatus by using the inside user information in the case where the collaborative authorization information retaining unit stores the collaborative authorization information.

### SUMMARY

In the case where application programs (abbreviated below as applications) that provide services are installed in respective multiple information processing apparatuses, and login operations are needed for the information processing apparatuses and the applications, it is necessary to perform the login operation for one of the information processing apparatuses to be used among the multiple information processing apparatuses and to subsequently perform the login operation again for the application that is installed in the one of the information processing apparatuses. In the case where the user performs the login operation again for the one of the information processing apparatuses, the login operation for the application is not needed, and the service that is provided by the application is usable if the state of logging in the application is maintained for a certain time. However, in the case where the user performs the login operation for another information processing apparatus among the multiple information processing apparatuses, it is necessary to perform the login operation again for the application, which is inconvenient for the user.

Aspects of non-limiting embodiments of the present disclosure relate to an information processing system, a non-transitory computer readable medium, and a method that enable, in the case where service functions are added into respective multiple information processing apparatuses, and a login operation for each information processing apparatus and a login operation for a service thereof are needed, the login operation for the service to be unnecessary after the login operation for one of the multiple information processing apparatuses and the login operation for the service thereof are performed even in the case where the login operation is subsequently performed for another one of the information processing apparatuses that differs from the one of the information processing apparatuses for which the login operation is performed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a plurality of information processing apparatuses; and a management server that manages the plurality of information processing apparatuses, each of the information processing apparatuses includes a first processor, the first processor is configured to: perform an authentication process for a user by using first identification information and first password information that are inputted by the user and permit the user who succeeds the authentication process to use a corresponding one of the information processing apparatuses in a case where a result of the authentication process is successful; transmit second identification information and second password information to an external server that manages an additional service and request the external server to perform the authentication process in a case where the second identification information and the second password information are inputted by the user to use the service that is usable in the corresponding one of the information processing apparatuses; and permit the user to use the service and transmit authentication token information that is transmitted when the external server sends back a message that represents success of authentication and user information that enables the user to be identified to the management server in a case where the external server sends back the message that represents the success of authentication, the management server includes a second processor and a storage unit, the second processor is configured to: acquire data relevant to a state of the plurality of information processing apparatuses by synchronously communicating with the plurality of information processing apparatuses to be managed and store the data as synchronous data in the storage unit; and associate the authentication token information that is transmitted from the first processor with the user information and store the authentication token information in the synchronous data of the corresponding one of the information processing apparatuses that transmits the authentication token information and in the synchronous data of another information processing apparatus that implements authentication management in common with the corresponding one of the information processing apparatuses, the first processor is configured to transmit the user information about the user who logs in to the management server in a case where the user performs the authentication process by using the first identification information and the first password information, the second processor is configured to transmit the authentication token information to the corresponding one of the information processing apparatuses that transmits the user information in a case where the authentication token information that is associated with the user information that is transmitted from the first processor is stored in the synchronous data of any one of the information processing apparatuses that implements the authentication management in common, and the first processor is configured to request the external server to perform the authentication process by using the authentication token information that is transmitted from the second processor and permit the user to use the service in a case where the external server sends back the message that represents the success of authentication.

### BRIEF DESCRIPTION OF THE DRAWINGS

Exemplary embodiments of the present disclosure will be described in detail based on the following figures, wherein:

FIG. 1 illustrates a system configuration of an information processing system according to an exemplary embodiment of the present disclosure;

FIG. 2 is a block diagram illustrating a hardware configuration of each of image forming apparatuses according to an exemplary embodiment of the present disclosure;

FIG. 3 is a block diagram illustrating a functional configuration of each of the image forming apparatuses according to an exemplary embodiment of the present disclosure;

FIG. 4 illustrates an example of a login screen of each of the image forming apparatuses;

FIG. 5 illustrates an example of a home screen of each of the image forming apparatuses;

FIG. 6 illustrates an example of a login screen for an application of each of the image forming apparatuses;

FIG. 7 is a block diagram illustrating a hardware configuration of a management server according to an exemplary embodiment of the present disclosure;

FIG. 8 is a block diagram illustrating a functional configuration of the management server according to an exemplary embodiment of the present disclosure;

FIG. 9 illustrates an operation for a first login when a user logs in the application from one of the image forming apparatuses in a base A;

FIG. 10 illustrates an example of authentication token information that is stored in synchronous data storage units;

FIG. 11 illustrates an operation for a second or more login when the user moves to a base B and logs in the application from another one of the image forming apparatuses;

FIG. 12 illustrates an operation for the first login in the case where permission to share authentication information is set for every group;

FIG. 13 illustrates an operation for the first login in the case where a user ID for logging in the image forming apparatuses differs between the bases A and B;

FIG. 14 illustrates the authentication token information that is associated with a mail address of the user and that is stored in the synchronous data storage units; and

FIG. 15 illustrates an operation for the second or more login when the user moves to the base B and logs in the application from the other one of the image forming apparatuses in the case where the user ID for logging in the image forming apparatuses differs between the bases A and B.

### DETAILED DESCRIPTION

An exemplary embodiment of the present disclosure will now be described in detail with reference to the drawings.

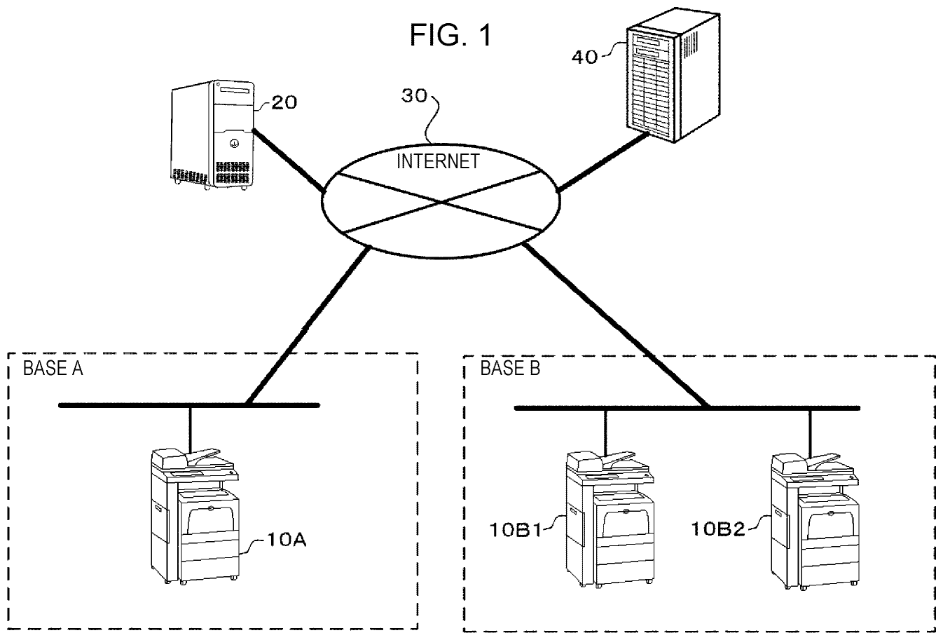

FIG. 1 illustrates a system configuration of an information processing system according to an exemplary embodiment of the present disclosure.

As illustrated in FIG. 1, the information processing system according to an exemplary embodiment of the present disclosure includes multiple image forming apparatuses 10A, 10B1, and 10B2, a management server 40 that manages the multiple image forming apparatuses 10A, 10B1, and 10B2, and an application server 20 that provides a function by using an application.

The multiple image forming apparatuses 10A, 10B1, and 10B2 are connected to the management server 40 and the application server 20 via the internet 30. The image forming apparatus 10A is installed in a base A of a company, and the image forming apparatuses 10B1 and 10B2 are installed in a base B of a company. In the case where the multiple image forming apparatuses 10A, 10B1, and 10B2 are not distinguished, these will be described as the image forming apparatuses 10.

When the multiple image forming apparatuses 10A, 10B1, and 10B2 are used, it is necessary to perform an authentication process by performing a login operation.

An application that provides a service is installed in each of the multiple image forming apparatuses 10A, 10B1, and 10B2. Also, when the service that is provided by the application is used, it is necessary to perform the authentication process by performing a login operation. As for the image forming apparatuses 10, the login operation for the application is performed, authentication information such as a user ID and a password is inputted, the inputted authentication information is consequently transmitted to the application server 20, and the authentication process is performed. When the result of the authentication process is successful, the function of the application is usable by the user. Examples of the function that is provided by the application include WEB services that enable the state of use of the image forming apparatuses 10 to be checked, a repair to be requested, an amount billed to be checked, and support information to be acquired.

For this reason, the user who wishes to use the application needs to log in one of the multiple image forming apparatuses 10A, 10B1, and 10B2 and subsequently perform the login operation again for the application that is installed in the one of the image forming apparatuses 10 in which the user logs. In the case where the user performs the login operation again for the one of the image forming apparatuses 10, the login operation for the application is not needed, and the service that is provided by the application is usable if the state of logging in the application is maintained for a certain time. However, in the case where the user performs the login operation for another one of the image forming apparatuses 10 among the multiple image forming apparatuses 10A, 10B1, and 10B2, it is necessary to perform the login operation again for the application, which is inconvenient for the user.

In view of this, as for the information processing system according to the present exemplary embodiment, a method described later may makes the login operation for the service unnecessary after the login operation for one of the image forming apparatuses 10 among the multiple image forming apparatuses 10A, 10B1, and 10B2 and the login operation for the service thereof are performed even in the case where the login operation is subsequently performed for another one of the image forming apparatuses 10 that differs from the one of the image forming apparatuses 10 for which the login operation is performed.

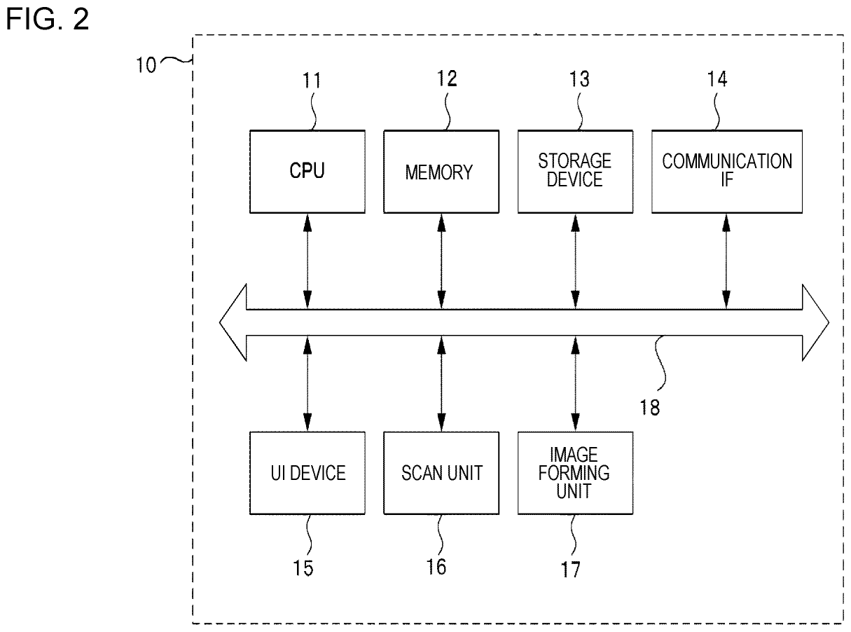

FIG. 2 illustrates a hardware configuration of each of the image forming apparatuses 10 of the information processing system according to the present exemplary embodiment.

As illustrated in FIG. 2, each of the image forming apparatuses 10 includes a CPU 11, a memory 12, a storage device 13 such as a hard disk drive, a communication interface (abbreviated as an IF) 14 that transmits and receives data to and from, for example, an external device via the internet 30, a user interface (abbreviated as a UI) device 15 that includes a touch screen or a liquid-crystal display and a keyboard, a scan unit 16, and an image forming unit 17. These components are connected to each other with a control bus 18 interposed therebetween.

The image forming unit 17 prints an image on a recording medium such as print paper through processes such as charging, exposure, development, transfer, and fixing.

The CPU 11 is a processor that performs a predetermined process, based on a control program stored in the memory 12 or the storage device 13 and that controls the operation of the image forming apparatus 10. In the description according to the present exemplary embodiment, the CPU 11 reads and runs the control program that is stored in the memory 12 or the storage device 13, but this is not a limitation. The control program may be provided by being recorded in a recording medium that is readable by a computer. For example, the program may be provided by being recorded in an optical disk such as a compact disc (CD)-read only memory (ROM) or a digital versatile disc (DVD)-read only memory (ROM) or by being recorded in a semiconductor memory such as a universal serial bus (USB) memory or a memory card. The control program may be acquired from an external device via a communication line that is connected to the communication interface 14. The control program may be provided, for example, as application software alone or may be incorporated as a function of the image forming apparatus 10 into software of devices thereof.

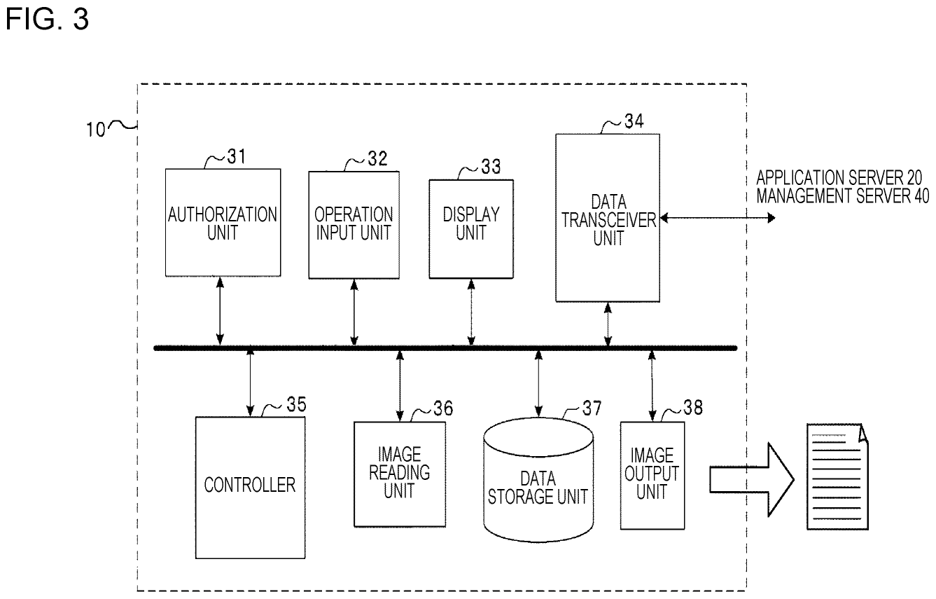

FIG. 3 is a block diagram illustrating a functional configuration of each of the image forming apparatuses 10 the function of which is fulfilled by performing the control program described above.

As illustrated in FIG. 3, each of the image forming apparatuses 10 according to the present exemplary embodiment includes an authorization unit 31, an operation input unit 32, a display unit 33, a data transceiver unit 34, a controller 35, an image reading unit 36, a data storage unit 37, and an image output unit 38.

The data transceiver unit 34 transmits and receives data to and from an external device such as the application server 20 or the management server 40.

The controller 35 controls the operation of the image forming apparatus 10. Specifically, the controller 35 controls the image reading unit 36 and the image output unit 38 to perform a scan process or a print process. For example, the controller 35 checks the user ID and the password that are inputted from the operation input unit 32, performs the authentication process for the user, and transmits the user ID and the password that are inputted for the application to the application server 20. The data storage unit 37 stores various kinds of data such as print data that is generated by the controller 35.

The display unit 33 is controlled by the controller 35 and displays various kinds of information for the user. The operation input unit 32 inputs various kinds of information about the operation that is performed by the user. As for the image forming apparatuses 10 according to the present exemplary embodiment, the display unit 33 and the operation input unit 32 are included in the touch screen.

The image output unit 38 outputs an image on a recording medium such as print paper, based on control of the controller 35. The image reading unit 36 reads a document image from a document that is placed thereon, based on the control of the controller 35.

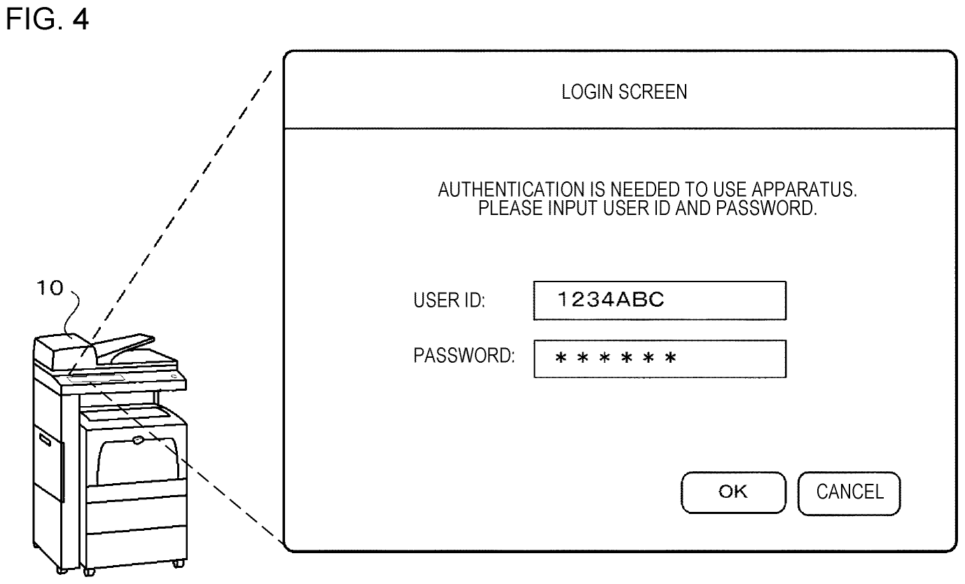

An operation until the user logs in one of the image forming apparatuses 10 and uses the function of the installed application will be described with reference to FIG. 4 to FIG. 6.

As illustrated in FIG. 4, the user inputs the user ID and the password for the one of the image forming apparatuses 10 into an operation screen of the one of the image forming apparatuses 10. The user ID that is used herein corresponds to identification information for identifying the user, and an example thereof may be the employee number of the user. In FIG. 4, it is seen that a character string of “1234ABC” is inputted as the user ID. Authentication may be implemented in a manner in which an IC card that is given to the user in advance touches an IC card reader of the one of the image forming apparatuses 10 instead of the input of the user ID and the password.

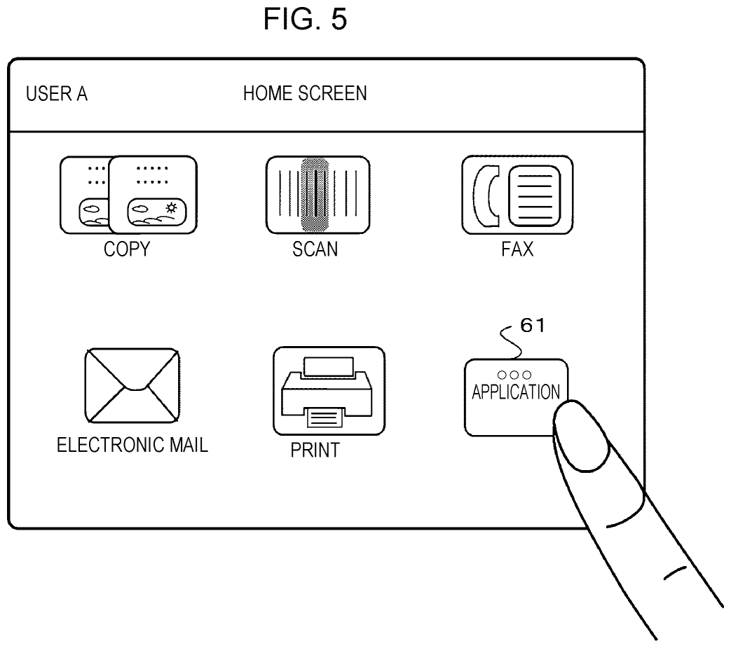

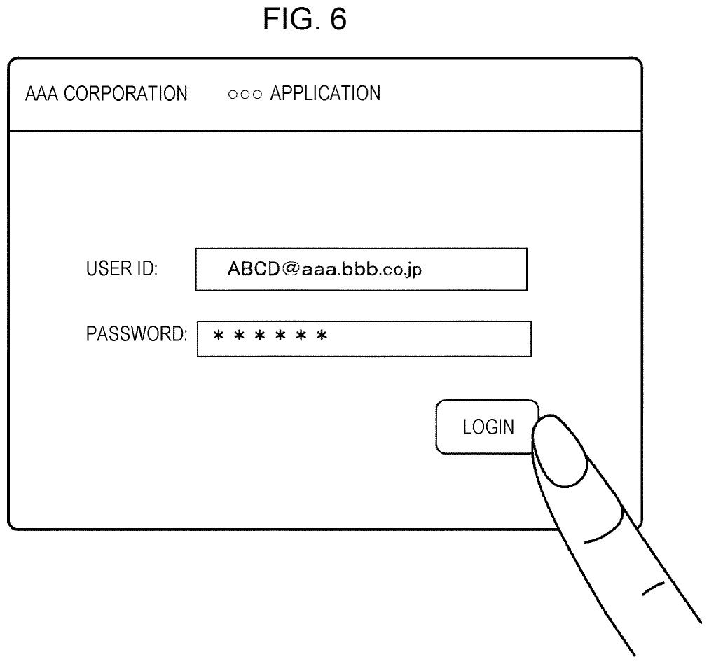

The user ID and the password are thus inputted, and the controller 35 subsequently implements the authentication for the user and displays a home screen illustrated in FIG. 5 on the display unit 33 if the result of the authentication is successful. An icon 61 named “000 application” is placed on the home screen. The user operates the icon 61, and consequently, the login screen for the application illustrated in FIG. 6 is displayed on the display unit 33.

The user inputs the user ID and the password for the application into the login screen for the application illustrated in FIG. 6, the user ID and the password are subsequently transmitted to the application server 20, and the authentication process is performed. If the result of the authentication process is successful, the function that is provided by the application is usable by the user. In the case illustrated in FIG. 6, a mail address of the user is set as the user ID for the application. For this reason, it is seen in FIG. 6 that a character string of “ABCD@aaa.bbb.co.jp” that is a mail address of a user A is inputted as the user ID.

The controller 35 thus performs the authentication process for the user by using the user ID and password information that are inputted by the user and permits the user who succeeds the authentication process to use the one of the image forming apparatuses 10 if the result of the authentication process is successful.

In the case where the user inputs the user ID for the application and the password information for the application in order to use an additional service that is usable in the one of the image forming apparatuses 10, the controller 35 transmits the user ID for the application and the password information for the application to the application server 20 that is an external server that manages the service of the application and requests the application server 20 to perform the authentication process.

In the case where the application server 20 sends back a message that represents the success of authentication, the user is permitted to use the service of the application, and authentication token information that is transmitted when the application server 20 sends back the message that represents the success of authentication and user information that enables the user to be identified are transmitted to the management server 40.

The authentication token information described herein is authentication information the expiration date of which is set and is usable any number of times before the expiration date. The use of the authentication token information enables the authentication to be provided without the user ID and the password. In the following description, the authentication token information is simply referred to as the authentication token in some cases.

In the description according to the present exemplary embodiment, the user ID that is needed to log in the image forming apparatuses 10 is used as the user information that enables the user to be identified. However, information other than the user ID is usable, provided that the information enables the user to be identified.

The information processing system according to the present exemplary embodiment provides a service called a digital shadow where various kinds of data such as an address list, device information, state information, history information, setting information about the image forming apparatuses 10 that are physical devices are synchronously retained in the management server 40 that is a cloud server. The use of the digital shadow enables the management server 40 to manage the states of the image forming apparatuses 10 even in the case where connection to the internet 30 is broken. In the case where the states of the multiple image forming apparatuses 10A, 10B1, and 10B2 are managed by the digital shadow, the data of the multiple image forming apparatuses 10A, 10B1, and 10B2 is retained as synchronous data in the cloud server.

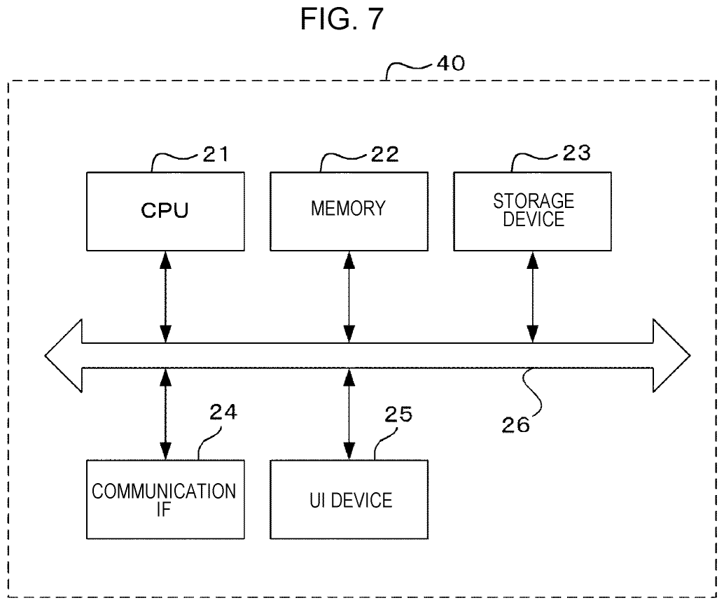

FIG. 7 illustrates a hardware configuration of the management server 40 of the information processing system according to the present exemplary embodiment.

As illustrated in FIG. 7, the management server 40 includes a CPU 21, a memory 22, a storage device 23 such as a hard disk drive, a communication interface (abbreviated as an IF) 24 that transmits and receives data to and from, for example, the image forming apparatuses 10 via the internet 30, and a user interface (abbreviated as a UI) device 25. These components are connected to each other with a control bus 26 interposed therebetween.

The CPU 21 is a processor that performs a predetermined process, based on a control program stored in the memory 22 or the storage device 23 and that controls the operation of the management server 40. In the description according to the present exemplary embodiment, the CPU 21 reads and runs the control program that is stored in the memory 22 or the storage device 23, but this is not a limitation. The control program may be provided by being recorded in a recording medium that is readable by a computer. For example, the program may be provided by being recorded in an optical disk such as a compact disc (CD)-read only memory (ROM) or a digital versatile disc (DVD)-read only memory (ROM) or by being recorded in a semiconductor memory such as a universal serial bus (USB) memory or a memory card. The control program may be acquired from an external device via a communication line that is connected to the communication interface 24. The control program may be provided, for example, as application software alone or may be incorporated as a function of the management server 40 into software of devices thereof.

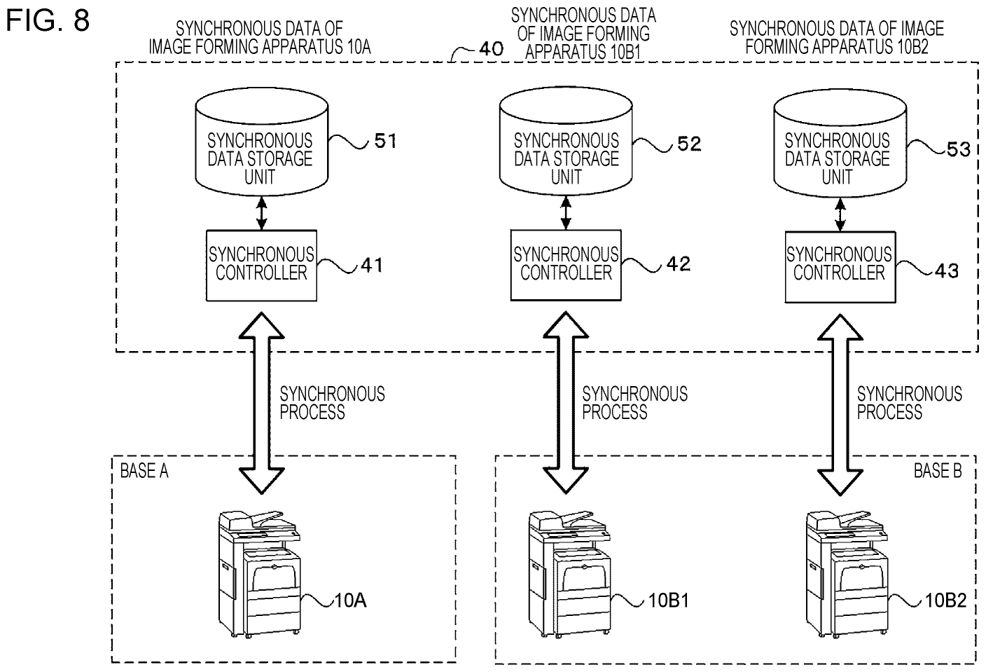

FIG. 8 is a block diagram illustrating a functional configuration of the management server 40 the function of which is fulfilled by performing the control program described above.

As illustrated in FIG. 8, the management server 40 includes synchronous controllers 41 to 43 and synchronous data storage units 51 to 53.

The synchronous controllers 41 to 43 acquire data relevant to the states of the image forming apparatuses 10A, 10B1, and 10B2 by synchronously communicating with the multiple image forming apparatuses 10A, 10B1, and 10B2 to be managed and store the data as the synchronous data in the synchronous data storage units 51 to 53.

The synchronous controllers 41 to 43 associate the authentication token information that is transmitted from the one of the image forming apparatuses 10 with the user information, store the authentication token information in the synchronous data of the one of the image forming apparatuses 10 that transmits the authentication token information and in the synchronous data of another image forming apparatus 10 that is configured to implement the authentication management in common with the one of the image forming apparatuses 10.

In the following description, the image forming apparatuses 10A, 10B1, and 10B2 are the image forming apparatuses 10 that implement the authentication management in common with each other. Examples of the multiple image forming apparatuses 10 that implement the authentication management in common with each other in the management server 40 include multiple image forming apparatuses 10 that are usable by the same user. Specifically, the multiple image forming apparatuses 10 that are usable by the same user are multiple image forming apparatuses 10 that are commonly used in the same company, the same department, or the same group.

For example, in the case where the authentication token information and the user information are transmitted from the image forming apparatus 10A to be managed, the synchronous controller 41 associates the authentication token information and the user information with each other and stores these as the synchronous data in the synchronous data storage unit 51. The synchronous controller 41 associates the authentication token information and the user information with each other and stores these as the synchronous data also in the synchronous data storage units 52 and 53.

When the user logs in the application at the second or more time, the controller 35 of the one of the image forming apparatuses 10 transmits the user information about the user who logs in to the management server 40 in the case where the user performs the authentication process by using the user ID and the password information for the one of the image forming apparatuses 10.

The synchronous controllers 41 to 43 of the management server 40 then transmit the authentication token information to the one of the image forming apparatuses 10 that transmits the user information in the case where the authentication token information that is associated with the user information that is transmitted from the one of the image forming apparatuses 10 is stored in the synchronous data of any one of the multiple image forming apparatuses 10A, 10B1, and 10B2 that implement the authentication management in common with each other.

As for the one of the image forming apparatuses 10 that receives the authentication token information, the controller 35 requests the application server 20 to perform the authentication process by using the authentication token information that is transmitted from the management server 40. In the case where the application server 20 sends back the message that represents the success of authentication, the controller 35 permits the user to use the service of the application.

The operation of the information processing system according to the present exemplary embodiment will now be described in detail with reference to the drawings.

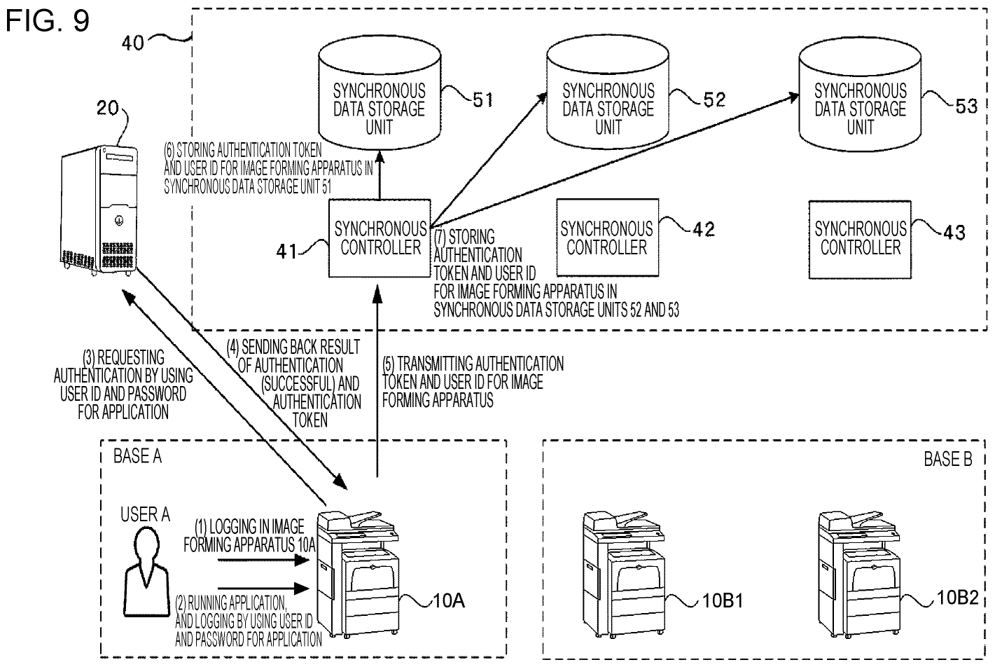

An operation for a first login when the user A logs in the application from the image forming apparatus 10A in the base A will now be described with reference to FIG. 9.
(1) The user A inputs the user ID and the password by operating an operation panel of the image forming apparatus 10A and logs in.
(2) Subsequently, the user A operates the operation panel of the image forming apparatus 10A, inputs the user ID and the password for the application, and logs in.
(3) The user ID and the password for the application are then transmitted from the image forming apparatus 10A to the application server 20, and the authentication is requested.
(4) The application server 20 then performs the authentication process by using the user ID and the password for the application that are transmitted and sends the result of the authentication and the authentication token back to the image forming apparatus 10A.
(5) The image forming apparatus 10A permits the user A to use the application and transmits the transmitted authentication token and the user ID for the image forming apparatuses 10 to the management server 40.
(6) As for the management server 40, the synchronous controller 41 then associates the transmitted authentication token and the user ID for the image forming apparatuses 10 with each other and stores these in the synchronous data storage unit 51.
(7) The synchronous controller 41 associates the transmitted authentication token and the user ID for the image forming apparatuses 10 with each other and stores these also in the synchronous data storage units 52 and 53.

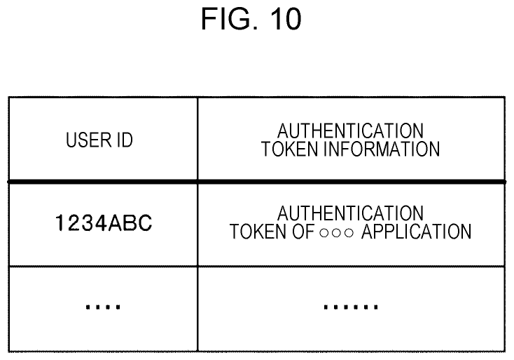

An example of the authentication token information that is stored in the synchronous data storage units 51, 52, and 53 in this way is illustrated in FIG. 10. As illustrated in FIG. 10, the authentication token information that is associated with the user ID is stored in the synchronous data storage units 51, 52, and 53.

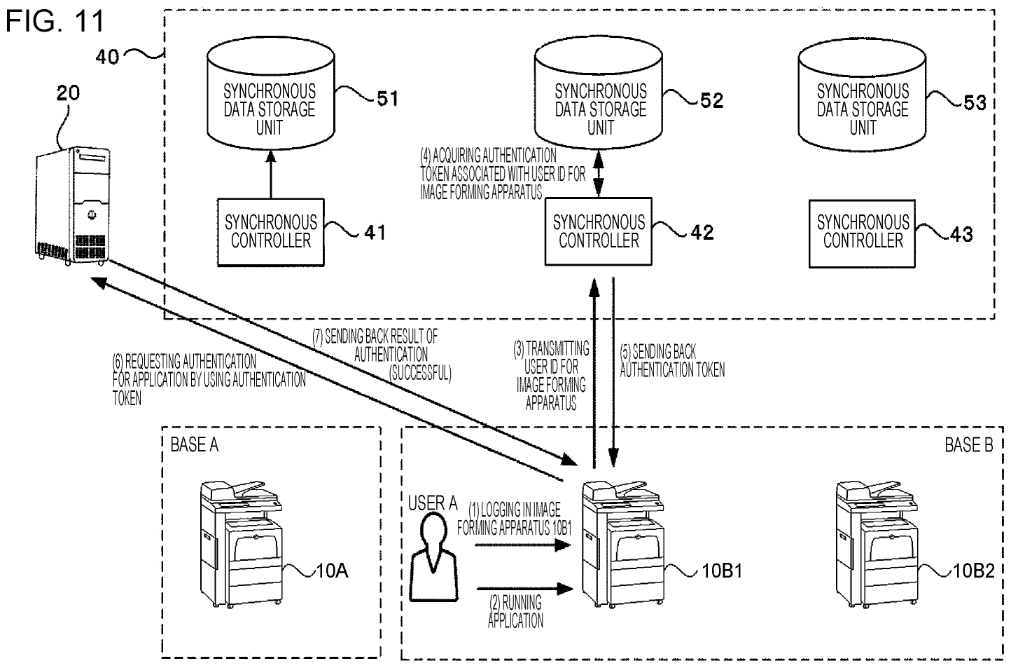

An operation for a second or more login when the user A described above moves to the base B and logs in the application from the image forming apparatus 10B1 will now be described with reference to FIG. 11.
(1) The user A operates an operation panel of the image forming apparatus 10B1 in the base B, inputs the user ID and the password, and logs in.
(2) Subsequently, the user A operates the operation panel of the image forming apparatus 10B1 and runs the application.
(3) The user ID “1234ABC” for the image forming apparatuses 10 is then transmitted from the image forming apparatus 10B1 to the management server 40.
(4) As for the management server 40, the synchronous controller 42 then acquires the authentication token that is associated with the transmitted user ID “1234ABC” for the image forming apparatuses 10 and that is stored from the synchronous data storage unit 52.
(5) The synchronous controller 42 sends the acquired authentication token back to the image forming apparatus 10B1.
(6) The image forming apparatus 10B1 then requests the application server 20 to implements the authentication of the application by using the authentication token that is sent back from the management server 40.
(7) As a result, the application server 20 performs the authentication process by using the transmitted authentication token, and the result of the authentication is sent back to the image forming apparatus 10B1. In the case where the result of the authentication is successful, the service that is provided by the application is usable by the user A in the image forming apparatus 10B1.

The service that is provided by the application is usable by the user A without the input of the user ID and the password for the application into the image forming apparatus 10B1 as described above.

### First Modification

According to the exemplary embodiment described above, the input of the user ID and the password may be omitted at the second or more login into the application regardless of the base, provided that the image forming apparatuses 10A, 10B1, and 10B2 that are installed therein belong to the same company. In some cases, however, the strictness of security is to be changed among groups such as departments even in the same company. For example, an image forming apparatus that is installed in an accounting department among the accounting department, a sales department, and a development department does not share the authentication information with the other departments and is configured to always request the input of the user ID and the password for logging in the application in some cases. In these cases, an administrator who manages machines in the company may set whether it is permitted to share the authentication information for every group.

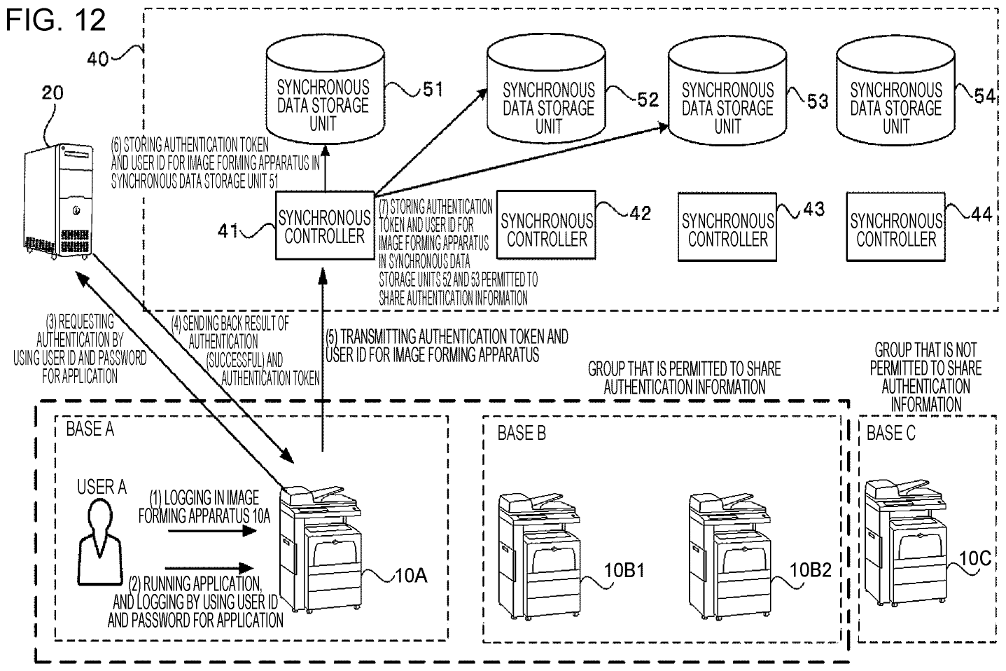

FIG. 12 illustrates an operation for the first login in the case where permission to share the authentication information is set for every group.

Referring to FIG. 12, it is seen that an image forming apparatus 10C that is installed in a base C is added. A synchronous controller 44 that manages the image forming apparatus 10C is added into the management server 40. The synchronous controller 44 synchronously communicates with the image forming apparatus 10C, consequently acquires data relevant to the state of the image forming apparatus 10C, and stores the data as the synchronous data in a synchronous data storage unit 54.

In the description herein, the bases A and B are set so as to belong to a group that is permitted to provide the authentication information, and the base C is set so as to belong a group that is not permitted to provide the authentication information.

For this reason, in FIG. 12, the operation up to the steps (1) to (6) is the same as that in FIG. 9, but the operation at the step (7) differs from that in FIG. 9.

At the step (7) in FIG. 12, the synchronous controller 41 stores the authentication token and the user ID that are transmitted in the synchronous data storage units 52 and 53 in a group that is permitted to share the situation of the authentication and does not store these in the synchronous data storage unit 54 in a group that is not permitted to share the situation of the authentication.

As a result, it is necessary to input the user ID and the password even in the case where the user A who logs in the application from the image forming apparatus 10A in the base A moves to the base C and logs in the application from the image forming apparatus 10C.

### Second Modification

According to the exemplary embodiment described above, the user ID and the authentication token information are associated with each other and are stored in the synchronous data storage units 51 to 53 of the management server 40. In some cases, however, the user ID that is used when the user logs in each of the image forming apparatuses 10 differs among the bases even through the user is the same. In the case of such an operation, when the same user moves to a different base, the input of the user ID and the password for logging in the application cannot be omitted even with the user ID and the authentication token information that are associated with each other being stored. In the case described below, the user ID is not used as the user information that enables the user to be identified, but the mail address of the user is used as the user information that enables the user to be identified.

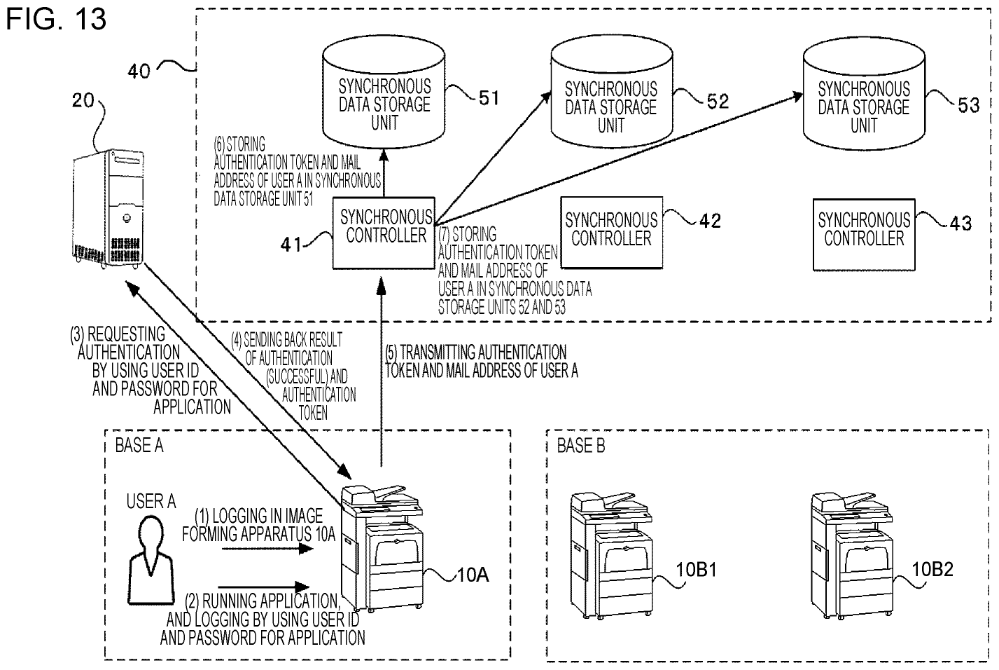

FIG. 13 illustrates an operation for the first login in the case where the user ID for logging in the image forming apparatuses 10 differs between the bases A and B.

In FIG. 13, the operation up to the steps (1) to (4) is the same as that in FIG. 9, but the operation at and after the step (5) differs from that in FIG. 9 as described later. At the steps (5) to (7) in FIG. 13, the operation described below is performed.
(5) The image forming apparatus 10A transmits the authentication token that is transmitted from the application server 20 and the mail address of the user A to the management server 40.
(6) As for the management server 40, the synchronous controller 41 then associates the authentication token and the mail address of the user A that are transmitted with each other and stores these in the synchronous data storage unit 51.
(7) The synchronous controller 41 associates the authentication token and the mail address of the user A that are transmitted with each other and stores these also in the synchronous data storage units 52 and 53.

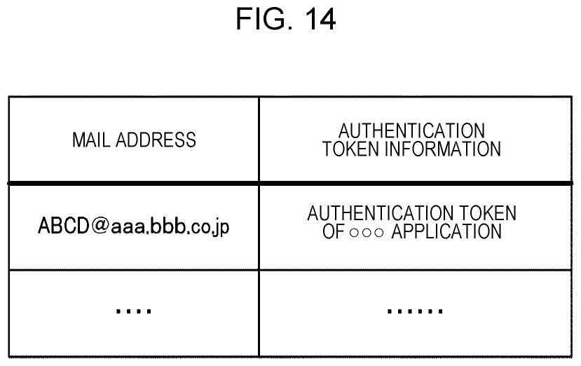

An example of the authentication token information that is stored in the synchronous data storage units 51, 52, and 53 in this way is illustrated in FIG. 14. As illustrated in FIG. 14, the authentication token information that is associated with the mail address of the user A is stored in the synchronous data storage units 51, 52, and 53.

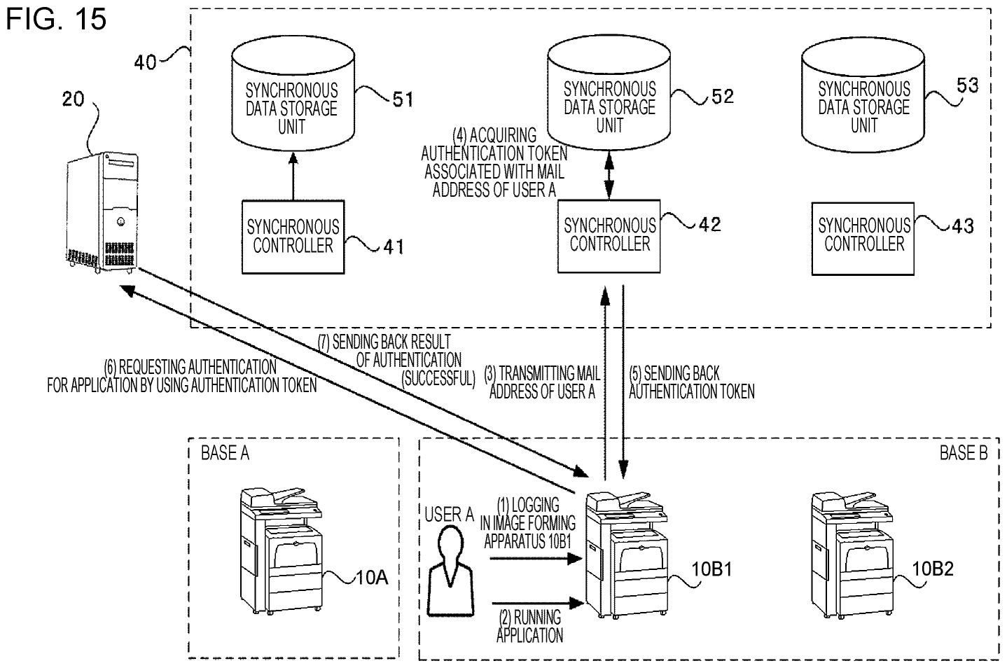

The operation for the second or more login when the user A described above moves to the base B and logs in the application from the image forming apparatus 10B1 will now be described with reference to FIG. 15.

In FIG. 15, the operation is the same as that in FIG. 11 except for the steps (3) and (4), and the operation at the steps (3) and (4) differs from that in FIG. 11 as described later. At the steps (3) and (4) in FIG. 15, the operation is performed as described below.
(3) The mail address “ABCD@aaa.bbb.co.jp” of the user A is transmitted from the image forming apparatus 10B1 to the management server 40.
(4) As for the management server 40, the synchronous controller 42 then acquires the authentication token that is associated with the transmitted mail address “ABCD@aaa.bbb.co.jp” of the user A and that is stored from the synchronous data storage unit 52.

In FIG. 15, the operation at and after the step (5) is the same as that in FIG. 11, and the description thereof is omitted.

According to the modification, in the case where a user logs in one of the image forming apparatuses 10 by using the user ID and the password, the controller 35 of the one of the image forming apparatuses 10 acquires the mail address of the user from registration information in the one of the image forming apparatuses 10. Specifically, the user information about the user is registered in the image forming apparatuses 10A, 10B1, and 10B2, and mail address information about the user is contained in the registered user information. In view of this, the controller 35 transmits the acquired mail address information and the authentication token information to the management server 40.

In the description herein, the mail address information about the user who logs in the one of the image forming apparatuses 10 is used as the user information that enables the user to be identified. In some cases, as illustrated in FIG. 6, the mail address of the user is used as the user ID for the application. In these cases, the mail address information about the user that is inputted as application ID and the authentication token information are transmitted to the management server 40 and are stored as the synchronous data.

According to the present exemplary embodiment, the meaning of the “system” includes a system that includes multiple devices and a system that includes a single device.

The present disclosure may be used for a program and a program product.

### Modifications

In the description according to the exemplary embodiment described above, the information processing apparatuses that use the application that is installed therein are the image forming apparatuses 10. However, the present disclosure is not limited to such a case, but information processing apparatuses such as mobile terminal apparatuses and personal computers that are capable of using an application that is installed therein may be used.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system includes: a plurality of information processing apparatuses; and a management server that manages the plurality of information processing apparatuses,
each of the information processing apparatuses includes a first processor,
the first processor is configured to:
   perform an authentication process for a user by using first identification information and first password information that are inputted by the user and permit the user who succeeds the authentication process to use a corresponding one of the information processing apparatuses in a case where a result of the authentication process is successful;
   transmit second identification information and second password information to an external server that manages an additional service and request the external server to perform the authentication process in a case where the second identification information and the second password information are inputted by the user to use the service that is usable in the corresponding one of the information processing apparatuses; and
   permit the user to use the service and transmit authentication token information that is transmitted when the external server sends back a message that represents success of authentication and user information that enables the user to be identified to the management server in a case where the external server sends back the message that represents the success of authentication,
the management server includes a second processor and a storage unit,
the second processor is configured to:
   acquire data relevant to a state of the plurality of information processing apparatuses by synchronously communicating with the plurality of information processing apparatuses to be managed and store the data as synchronous data in the storage unit; and
   associate the authentication token information that is transmitted from the first processor with the user information and store the authentication token information in the synchronous data of the corresponding one of the information processing apparatuses that transmits the authentication token information and in the synchronous data of another information processing apparatus that implements authentication management in common with the corresponding one of the information processing apparatuses,
the first processor is configured to transmit the user information about the user who logs in to the management server in a case where the user performs the authentication process by using the first identification information and the first password information,
the second processor is configured to transmit the authentication token information to the corresponding one of the information processing apparatuses that transmits the user information in a case where the authentication token information that is associated with the user information that is transmitted from the first processor is stored in the synchronous data of any one of the information processing apparatuses that implements the authentication management in common, and
the first processor is configured to request the external server to perform the authentication process by using the authentication token information that is transmitted from the second processor and permit the user to use the service in a case where the external server sends back the message that represents the success of authentication.
   (((2)))

As for the information processing system described in (((1))),
the user information is the first identification information that is needed for logging in the plurality of information processing apparatuses.
   (((3)))

As for the information processing system described in (((1))),
the first processor is configured to:
acquire the user information about a user from registration information in the corresponding one of the information processing apparatuses in a case where the user logs in the corresponding one of the information processing apparatuses by using the first identification information and the first password information; and
transmit the user information acquired and the authentication token information to the management server.
   (((4)))

As for the information processing system described in (((3))),
the user information is mail address information about the user who logs in the corresponding one of the information processing apparatuses.
   (((5)))

As for the information processing system described in any one of (((1))) to (((4))),
a plurality of information processing apparatuses that implements the authentication management in common with each other in the management server includes a plurality of information processing apparatuses that is usable by the same user.
   (((6)))

As for the information processing system described in (((5))),
the plurality of information processing apparatuses that is usable by the same user is commonly used in the same company, the same department, or the same group.
   (((7)))

A program causes a computer to execute a process for controlling an operation of an information processing system that includes a plurality of information processing apparatuses and a management server that manages the plurality of information processing apparatuses, and the process includes:
performing an authentication process for a user by using first identification information and first password information that are inputted by the user and permitting the user who succeeds the authentication process to use a corresponding one of the information processing apparatuses in a case where a result of the authentication process is successful;
transmitting second identification information and second password information to an external server that manages an additional service and requesting the external server to perform the authentication process in a case where the second identification information and the second password information are inputted by the user to use the service that is usable in the corresponding one of the information processing apparatuses;
permitting the user to use the service and transmitting authentication token information that is transmitted when the external server sends back a message that represents success of authentication and user information that enables the user to be identified to the management server in a case where the external server sends back the message that represents the success of authentication;
acquiring data relevant to a state of the plurality of information processing apparatuses by synchronously communicating with the plurality of information processing apparatuses to be managed and storing the data as synchronous data;
associating the authentication token information that is transmitted from any one of the information processing apparatuses with the user information and storing the authentication token information in the synchronous data of the corresponding one of the information processing apparatuses that transmits the authentication token information and in the synchronous data of another information processing apparatus that implements authentication management in common with the corresponding one of the information processing apparatuses;
transmitting the user information about the user who logs in to the management server in a case where the user performs the authentication process by using the first identification information and the first password information;
transmitting the authentication token information to the corresponding one of the information processing apparatuses that transmits the user information in a case where the authentication token information that is associated with the user information that is transmitted from any one of the information processing apparatuses is stored in the synchronous data of any one of the information processing apparatuses that implements the authentication management in common; and
requesting the external server to perform the authentication process by using the authentication token information that is transmitted from the management server and permitting the user to use the service in a case where the external server sends back the message that represents the success of authentication.

What is claimed is:

1. An information processing system comprising:
a plurality of information processing apparatuses; and
a management server that manages the plurality of information processing apparatuses,
wherein each of the information processing apparatuses includes a first processor,
wherein the first processor is configured to:
perform an authentication process for a user by using first identification information and first password information that are inputted by the user and permit the user who succeeds the authentication process to use a corresponding one of the information processing apparatuses in a case where a result of the authentication process is successful;
transmit second identification information and second password information to an external server that manages an additional service and request the external server to perform the authentication process in a case where the second identification information and the second password information are inputted by the user to use the service that is usable in the corresponding one of the information processing apparatuses; and
permit the user to use the service and transmit authentication token information that is transmitted when the external server sends back a message that represents success of authentication and user information that enables the user to be identified to the management server in a case where the external server sends back the message that represents the success of authentication,
wherein the management server includes a second processor and a storage unit,
wherein the second processor is configured to:
acquire data relevant to a state of the plurality of information processing apparatuses by synchronously communicating with the plurality of information processing apparatuses to be managed and store the data as synchronous data in the storage unit; and
associate the authentication token information that is transmitted from the first processor with the user information and store the authentication token information in the synchronous data of the corresponding one of the information processing apparatuses that transmits the authentication token information and in the synchronous data of another information processing apparatus that implements authentication management in common with the corresponding one of the information processing apparatuses,
wherein the first processor is configured to transmit the user information about the user who logs in to the management server in a case where the user performs the authentication process by using the first identification information and the first password information,
wherein the second processor is configured to transmit the authentication token information to the corresponding one of the information processing apparatuses that transmits the user information in a case where the authentication token information that is associated with the user information that is transmitted from the first processor is stored in the synchronous data of any one of the information processing apparatuses that implements the authentication management in common, and
wherein the first processor is configured to request the external server to perform the authentication process by using the authentication token information that is transmitted from the second processor and permit the user to use the service in a case where the external server sends back the message that represents the success of authentication.

2. The information processing system according to claim 1,
wherein the user information is the first identification information that is needed for logging in the plurality of information processing apparatuses.

3. The information processing system according to claim 1,
wherein the first processor is configured to:
acquire the user information about a user from registration information in the corresponding one of the information processing apparatuses in a case where the user logs in the corresponding one of the information processing apparatuses by using the first identification information and the first password information; and
transmit the user information acquired and the authentication token information to the management server.

4. The information processing system according to claim 3,
wherein the user information is mail address information about the user who logs in the corresponding one of the information processing apparatuses.

5. The information processing system according to claim 1,
wherein a plurality of information processing apparatuses that implements the authentication management in common with each other in the management server includes a plurality of information processing apparatuses that is usable by the same user.

6. The information processing system according to claim 5,
wherein the plurality of information processing apparatuses that is usable by the same user is commonly used in the same company, the same department, or the same group.

7. A non-transitory computer readable medium storing a program causing a computer to execute a process for controlling an operation of an information processing system that includes a plurality of information processing apparatuses and a management server that manages the plurality of information processing apparatuses, the process comprising:
performing an authentication process for a user by using first identification information and first password information that are inputted by the user and permitting the user who succeeds the authentication process to use a corresponding one of the information processing apparatuses in a case where a result of the authentication process is successful;
transmitting second identification information and second password information to an external server that manages an additional service and requesting the external server to perform the authentication process in a case where the second identification information and the second password information are inputted by the user to use the service that is usable in the corresponding one of the information processing apparatuses;
permitting the user to use the service and transmitting authentication token information that is transmitted when the external server sends back a message that represents success of authentication and user information that enables the user to be identified to the management server in a case where the external server sends back the message that represents the success of authentication;
acquiring data relevant to a state of the plurality of information processing apparatuses by synchronously communicating with the plurality of information processing apparatuses to be managed and storing the data as synchronous data;
associating the authentication token information that is transmitted from any one of the information processing apparatuses with the user information and storing the authentication token information in the synchronous data of the corresponding one of the information processing apparatuses that transmits the authentication token information and in the synchronous data of another information processing apparatus that implements authentication management in common with the corresponding one of the information processing apparatuses;
transmitting the user information about the user who logs in to the management server in a case where the user performs the authentication process by using the first identification information and the first password information;
transmitting the authentication token information to the corresponding one of the information processing apparatuses that transmits the user information in a case where the authentication token information that is associated with the user information that is transmitted from any one of the information processing apparatuses is stored in the synchronous data of any one of the information processing apparatuses that implements the authentication management in common; and
requesting the external server to perform the authentication process by using the authentication token information that is transmitted from the management server and permitting the user to use the service in a case where the external server sends back the message that represents the success of authentication.

8. A method of controlling an operation of an information processing system that includes a plurality of information processing apparatuses and a management server that manages the plurality of information processing apparatuses, the method comprising:
performing an authentication process for a user by using first identification information and first password information that are inputted by the user and permitting the user who succeeds the authentication process to use a corresponding one of the information processing apparatuses in a case where a result of the authentication process is successful;
transmitting second identification information and second password information to an external server that manages an additional service and requesting the external server to perform the authentication process in a case where the second identification information and the second password information are inputted by the user to use the service that is usable in the corresponding one of the information processing apparatuses;
permitting the user to use the service and transmitting authentication token information that is transmitted when the external server sends back a message that represents success of authentication and user information that enables the user to be identified to the management server in a case where the external server sends back the message that represents the success of authentication;
acquiring data relevant to a state of the plurality of information processing apparatuses by synchronously communicating with the plurality of information processing apparatuses to be managed and storing the data as synchronous data;
associating the authentication token information that is transmitted from any one of the information processing apparatuses with the user information and storing the authentication token information in the synchronous data of the corresponding one of the information processing apparatuses that transmits the authentication token information and in the synchronous data of another information processing apparatus that implements authentication management in common with the corresponding one of the information processing apparatuses;
transmitting the user information about the user who logs in to the management server in a case where the user performs the authentication process by using the first identification information and the first password information;
transmitting the authentication token information to the corresponding one of the information processing apparatuses that transmits the user information in a case where the authentication token information that is associated with the user information that is transmitted from any one of the information processing apparatuses is stored in the synchronous data of any one of the information processing apparatuses that implements the authentication management in common; and
requesting the external server to perform the authentication process by using the authentication token information that is transmitted from the management server and permitting the user to use the service in a case where the external server sends back the message that represents the success of authentication.
